(19) United States
(12) Patent Application Publication
(10) Pub. No.: US 2015/0108293 A1
(43) Pub. Date: Apr. 23, 2015

(54) Teetering Electronic Tablet Stand

(71) Applicant: Kevin Welsford Yorke, Derry, NH (US)

(72) Inventor: Kevin Welsford Yorke, Derry, NH (US)

(21) Appl. No.: 14/061,692

(22) Filed: Oct. 23, 2013

(51) Int. Cl. F16M 11/10

(52) U.S. Cl. CPC F16M 11/10
USPC 248/122.1

(57) ABSTRACT

This new tilting stand is made to hold securely an electronic computer device referred to as a “Tablet”. The tablet device teeters on the stand at a pivot or axis point in order to cause the device's screen to electronically rotate and orientate itself for use by a second viewer at the opposing side of the first viewer. Used in Gaming, Ecommerce, point of sale and as a retail store register.

### DETAILED SPECIFICATION OF THE INVENTION

A tablet stand will be made of a stationary bottom base 1, attached to the base will be stationary posts 2 and a pivot shaft 3 affixed to the post which functions as an axis. Platform 4 will be attached to the shaft in which a tablet device will be securely mounted. The platform will be freely to teeter back and forth as many times as user desires. The teetering will cause the device's screen to electronically rotate and orientate itself to user's position.

### DESCRIPTION OF THE SEVERAL VIEWS OF THE INVENTION

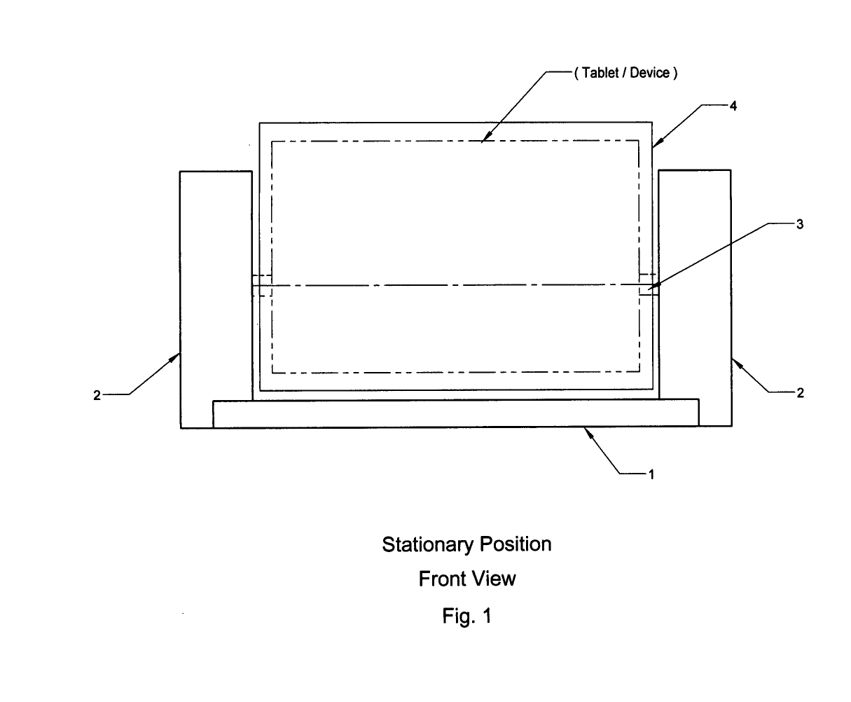

FIG. 1 is a front view of the Tablet Stand invention with a tablet device in a user's stationary position.

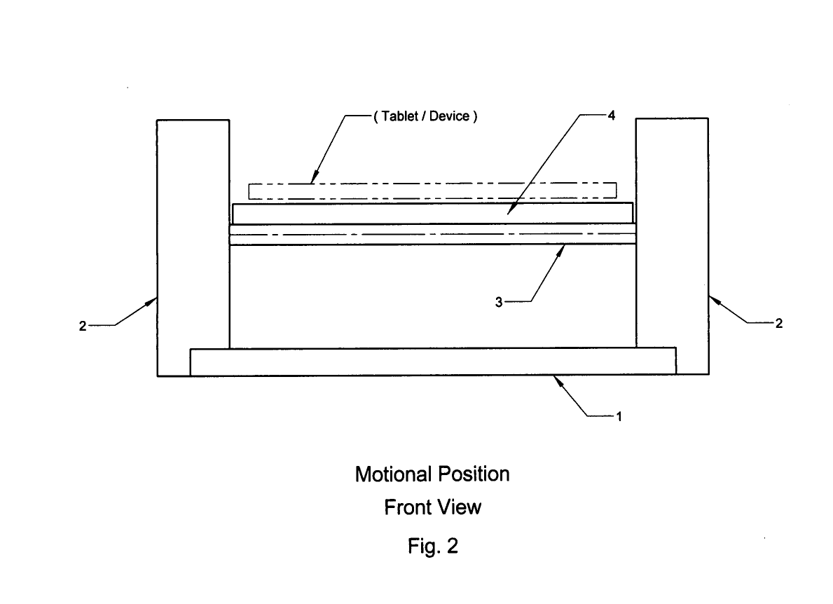

FIG. 2 is a front view of the Tablet Stand invention in motion to the user's opposite stationary position.

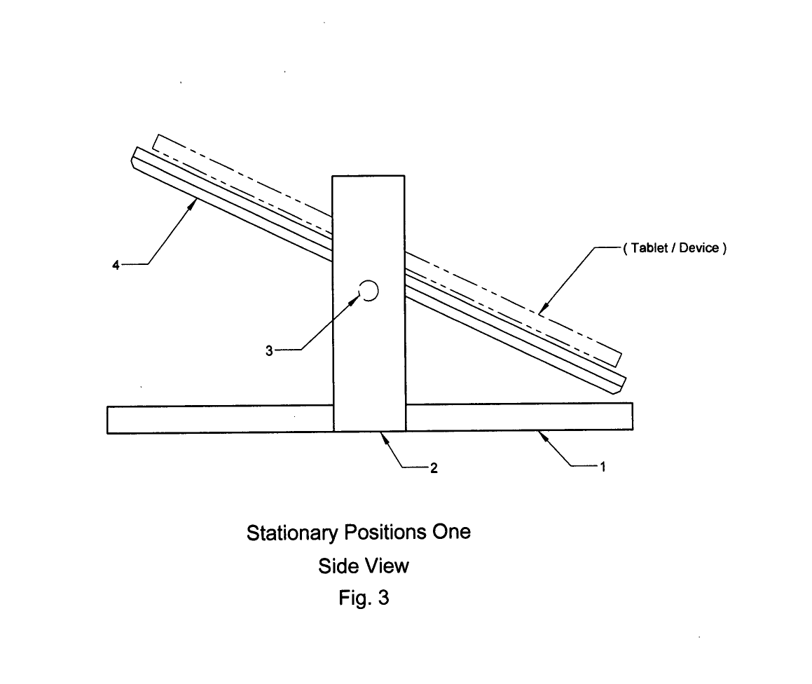

FIG. 3 is a side view of the Tablet Stand invention with a tablet device in a user's stationary position.

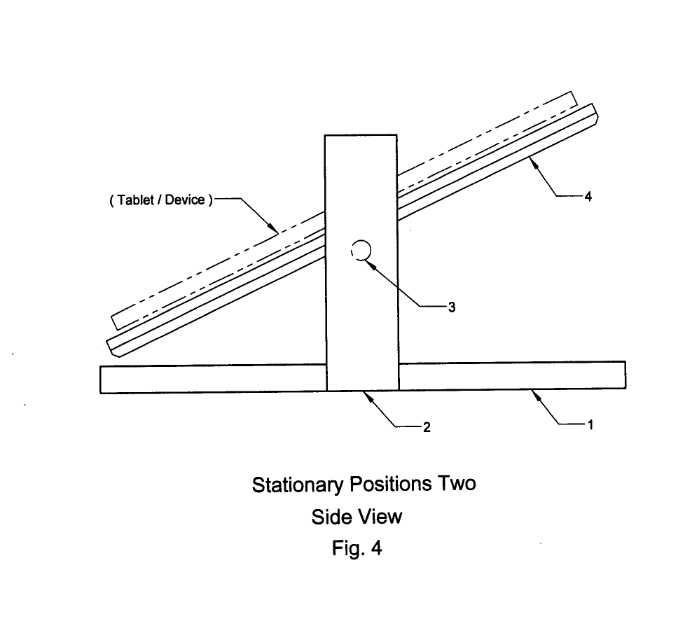

FIG. 4 is a side view of the Tablet Stand invention with a tablet device in a user's opposite stationary position.

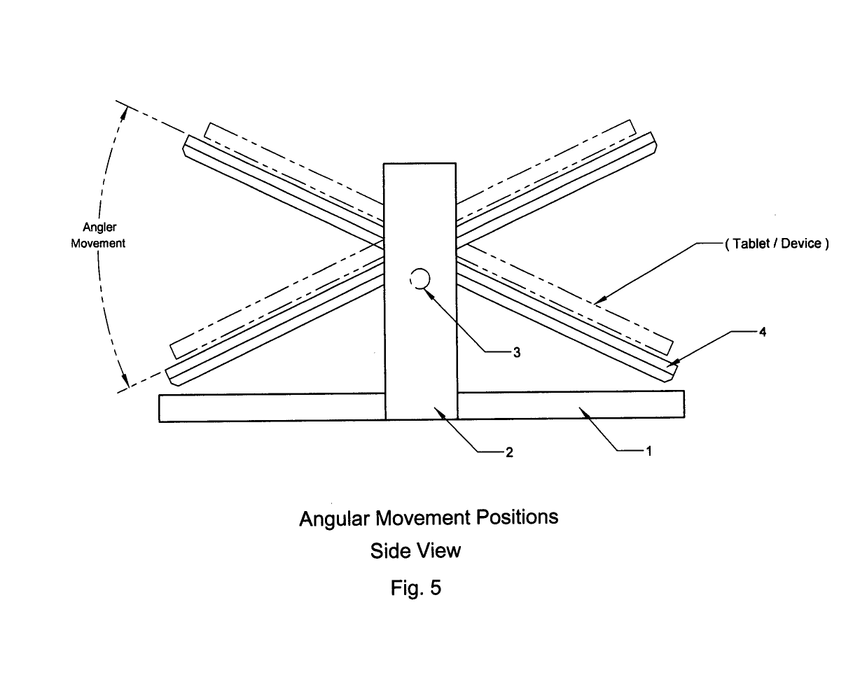

FIG. 5 is a side view of the Tablet Stand invention in angular movement positions to the users' position.

I claim:

1. the electronic tablet stand that functions in a way that it cause the tablets screen to self rotate in order that two users can use the device.
